(19) United States
(12) Patent Application Publication
(10) Pub. No.: US 2020/0176740 A1
(43) Pub. Date: Jun. 4, 2020

(54) ELECTRICITY STORAGE BATTERY AND CORRESPONDING THERMAL REGULATION ELEMENT

(71) Applicant: FAURECIA SYSTEMES D'ECHAPPEMENT, Nanterre (FR)

(72) Inventors: Jean-Baptiste CASSARD, Change (FR); Christian COTTE, Saint Dizier l'Evêque (FR); Frederic GREBER, Ecot (FR)

(21) Appl. No.: 16/702,200

(22) Filed: Dec. 3, 2019

(30) Foreign Application Priority Data
Dec. 3, 2018 (FR) 18 72233

(51) Int. Cl. H01M 2/10; H01M 2/02

(52) U.S. Cl. CPC H01M 2/1094; H01M 2/1083; H01M 2/024

(57) ABSTRACT

A thermal regulation element that includes an intermediate cover interposed between the first and second levels of electricity storage cells, with first and second flow volumes for a thermal regulation fluid being formed on first and second major faces of the intermediate cover, a first thermally conductive plate being disposed against the first major face of the intermediate cover and closing the first flow volume, and a second thermally conductive plate being disposed against the second major face of the intermediate cover and closing the second flow volume.

### TECHNICAL FIELD

The invention generally relates to electricity storage batteries, especially batteries for a motor vehicle.

### BACKGROUND

Such batteries generally include a large number of electricity storage cells in order to produce significant electrical power. They accordingly release a large amount of heat when they are in operation.

These batteries are thus equipped with a cooling circuit in order to evacuate the heat released.

The arrangement of the cooling circuit is particularly complex when the electricity storage cells of the battery are arranged on two levels.

It is possible to arrange such a cooling circuit using mainly metal components.

However, such a solution significantly increases the weight and bulk of the battery.

### SUMMARY

In this context, the invention aims to provide a solution for the thermal regulation of a two-level battery, which is compact and does not penalize the weight of the battery.

To this end and according to a first aspect, the invention relates to a thermal regulation element for an electricity storage battery, wherein the battery comprises:
a plurality of electricity storage cells, arranged on a first level; and
a plurality of electricity storage cells, arranged on a second level;
   wherein the thermal regulation element comprises:
an intermediate cover interposed between the first and second levels, the intermediate cover being made of a composite material and having large first and second faces respectively facing the first and second levels, first and second flow volumes for a thermal regulation fluid being formed on the first and second major faces;
a first thermally conductive plate being disposed against the first major face of the intermediate cover and closing the first flow volume formed on the first major face of the intermediate cover; and
a second thermally conductive plate being disposed against the second major face of the intermediate cover and closing the second flow volume formed on the second major face of the intermediate cover.

Thus, the same thermal regulation element makes it possible to regulate the temperature of the two levels of electricity storage cells. The use of an intermediate cover made of a composite material makes it possible to drastically reduce the weight of the thermal regulation element. The performance of the thermal regulation element is high because the heat transfer is effected via thermally conductive plates. The fact of making the intermediate cover of composite material also makes it possible to give the first and second fluid flow volumes forms adapted to the arrangement of the two levels of electricity storage cells. This ensures efficient flow of the thermal regulation fluid, and contributes to the performance of the thermal regulation element.

Furthermore, the thermal regulation element may have one or more of the following features, considered individually or in any technically feasible combination:
the first thermally conductive plate and/or the second thermally conductive plate is sealingly adhered to the intermediate cover;
the intermediate cover comprises a thermal regulation fluid inlet opening at the first major face of the intermediate cover and a thermal regulation fluid outlet opening at the first large face of the intermediate cover, wherein the intermediate cover defines at least one thermal regulation fluid flow channel from the thermal regulation fluid inlet to the thermal regulation fluid outlet through the first and second flow volumes;
the at least one fluid flow channel comprises an upstream section formed on the first major face of the intermediate cover in the first flow volume and fluidly connecting the thermal regulation fluid inlet to the second flow volume, and a downstream section formed on the first major face of the intermediate cover in the first flow volume and fluidly connecting the second flow volume to the thermal regulation fluid outlet;
the first and second flow volumes are separated from one another by a partition pierced by at least one upstream communication opening and at least one downstream communication opening, the second major face of the intermediate cover bearing reliefs delimiting in the second flow volume an intermediate section of the at least one thermal regulation fluid flow channel fluidly connecting the at least one upstream communication opening to the at least one downstream communication opening, the upstream section fluidly connecting the thermal regulation fluid inlet opening to the at least one upstream opening, the downstream section fluidly connecting the at least one downstream opening to the thermal regulation fluid outlet;
the intermediate cover comprises a window between the first and second flow volumes, wherein the window covers at least 50% of the surface of the second thermally conductive plate;
the upstream section fluidically connects the heat regulation fluid inlet to the window, while the downstream section fluidly connects the window to the heat regulation fluid outlet;
the intermediate cover comprises a grid extending in the window and guiding the thermal regulation fluid from the upstream section to the downstream section of the at least one thermal regulation fluid flow channel.
the thermal regulation fluid inlet and outlet are located at a first longitudinal end of the intermediate cover, the second thermally conductive plate being located at a second longitudinal end of the intermediate cover opposite to the first.

According to a second aspect, the invention relates to a battery for storing electricity, comprising:
a plurality of electricity storage cells, arranged on a first level;
a plurality of electricity storage cells, arranged on a second level; and
a thermal regulation element having the above characteristics and interposed between the first and second levels, the first thermally conductive plate being in thermal contact with the first level of the electricity storage cells, the second thermally conductive plate being in thermal contact with the second level of the electricity storage cells.

The battery may also have one or more of the following characteristics considered individually or in any technically feasible combination:
the battery comprises a tray receiving the first level of electricity storage cells, the tray having an edge defining an opening closed by the thermal regulation element;
the first thermally conductive plate covers the entire opening and extends beyond the edge outside the opening;
the tray comprises a bottom, a side wall, and transverse reinforcements placed inside the tray and rigidly fixed to the bottom, while the first level of electricity storage cells is distributed between the transverse reinforcements;
the battery comprises at least one outer reinforcement disposed outside the tray along the side wall and rigidly fixed to at least one of the transverse reinforcements;
the battery has a cover attached to the intermediate cover, wherein the second level of electricity storage cells is housed between said cover and the intermediate cover;
the second level electricity storage cells are placed in line with the second thermally conductive plate.

According to a third aspect, the invention relates to a vehicle comprising an electricity storage battery having the above characteristics.

### BRIEF DESCRIPTION OF THE DRAWINGS

Other features and advantages of the invention will become apparent upon reading the detailed description given below, for information only and in no way limitative, with reference to the appended figures, wherein:

FIG. 1 shows an exploded perspective view of an electricity storage battery according to an embodiment of the invention, the thermal regulation element being according to a first embodiment;

FIG. 2 shows a simplified schematic representation of the battery of FIG. 1, in longitudinal section;

FIGS. 3 and 4 show perspective views of each of the first and second major faces of the intermediate cover of the battery of FIG. 1;

FIGS. 5 and 6 show perspective views of each of the first and second major faces of the intermediate cover of a second embodiment of the thermal regulation element;

FIG. 7 shows a cross-sectional view of a battery equipped with the thermal regulation element of FIGS. 5 and 6; and

FIG. 8 shows a schematic representation illustrating a detail of an embodiment of the battery of the invention.

### DETAILED DESCRIPTION

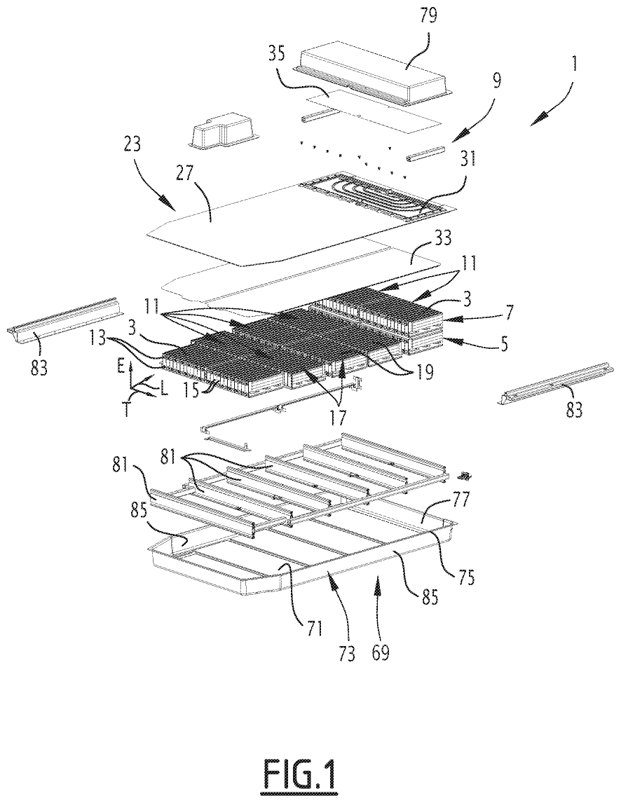

The electricity storage battery 1 shown in FIG. 1 is intended to equip a vehicle, typically a motor vehicle such as a car, a bus or a truck.

The vehicle may be, for example, a vehicle powered by an electric motor, the motor being electrically powered by the electric battery. In a variant, the vehicle is of the hybrid type and thus comprises a combustion engine and an electric motor powered electrically by the electric battery. According to yet another variant, the vehicle may be propelled by a combustion engine, wherein the battery 1 is provided to electrically power other equipment of the vehicle, for example the starter, the lights, etc.

The electricity storage battery 1 comprises a plurality of electricity storage cells 3, arranged on a first level 5, and a plurality of electricity storage cells 3, arranged on a second level 7.

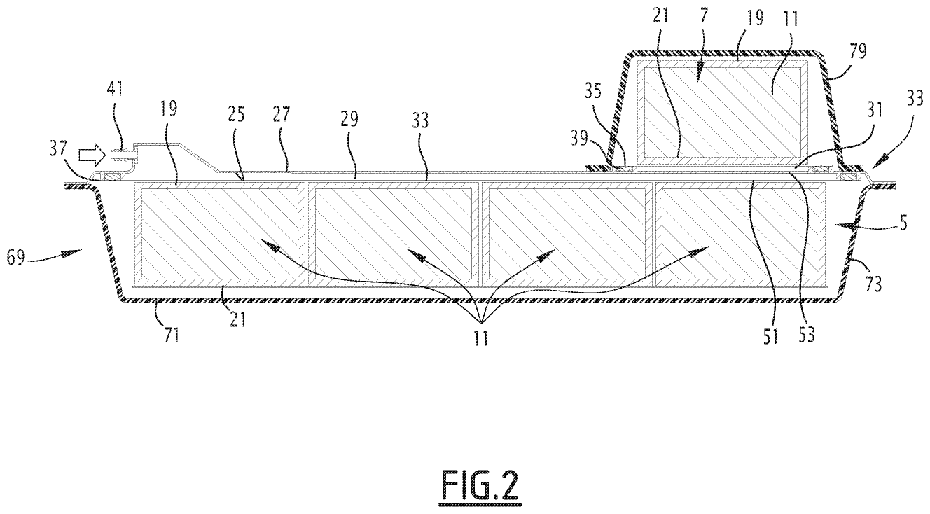

The electricity storage battery 1 further comprises a thermal regulation element 9, interposed between the first and second levels 5, 7 (see in particular FIG. 2).

The battery typically comprises a large number of cells 3 for storing electricity, typically several tens of electricity storage cells 3.

The electricity storage cells 3 are of all suitable types: lithium-ion polymer (Li-Po), lithium-iron-phosphate (LFP), lithium-cobalt (LCO), lithium-manganese (LMO) lithium cells), nickel-manganese-cobalt (NMC) or NiMH type (nickel metal hydride).

The electricity storage cells 3 are distributed in one or more modules 11, typically in several modules 11.

In the example shown in the figures, the electricity storage battery 1 comprises ten modules 11 at the first level, and two modules 11 at the second level.

The number of modules 11 is a function of the desired capacity for the battery 1.

In the same module 11, the electricity storage cells 3 are juxtaposed transversely.

The transverse direction is represented by the arrow T in FIG. 1.

The electricity storage cells 3 have respective electrodes 13, typically two electrodes 13 per electricity storage cell. The electrodes 13 of the electricity storage cells of the same module 11 are electrically connected to each other in series and/or in parallel.

Typically, the electricity storage cells 3 are prismatic cells, and each comprises a body of parallelepipedal general shape. The electricity storage cells 3 are all of the same size. The body of each electricity storage cell 3 has two side faces opposite one another, upper and lower faces opposite one another, a front face 15 carrying the electrodes 13 and a rear face opposite the front face 15. The side faces are perpendicular to the transverse direction T. The upper and lower faces are perpendicular to an elevation direction, shown by the arrow E in FIG. 1. The front and rear faces 15 are perpendicular in a longitudinal direction, indicated by the arrow L in FIG. 1.

The longitudinal L, transverse T and elevation E directions are perpendicular to each other.

The side faces of the electricity storage cells 3 of the same module 11 are pressed against each other, as illustrated in FIG. 1.

Each module 11 comprises an envelope 17, in which are housed the electricity storage cells 3 belonging to said module 11. The envelope 17 has upper and lower surfaces 19, 21, opposite to each other, and against which the upper and lower faces of the electricity storage cells of said corresponding module 11 are placed.

If necessary, a thermal paste may be interposed between the upper faces of the electricity storage cells and the envelope 17, and/or between the lower faces of the electricity storage cells 3 and the envelope 17.

In a variant, the electricity storage cells 3 are pocket-type cells, cylindrical cells, or cells of any other suitable type.

One level of the battery is defined here as being the set of all the electricity storage cells 3 situated at the same level in a given direction, without stacking or superposition of two electricity storage cells in said direction.

In the example shown in the figures, one level corresponds to the set of electricity storage cells 3 located at the same level in the direction of elevation E. All the electricity storage cells 3 of the first level 5 are located at the same level in the direction of elevation E. All the electricity storage cells 3 of the second level 7 are located at the same level in the direction of elevation E. In the representation of the figures, the second level 7 is located above the first level 5 in the direction of elevation E.

The thermal regulation element 9 is interposed between the first and second levels 5, 7 in the sense that it extends between the first and second levels 5, 7 along the elevation direction E.

In FIG. 1, the thermal regulation element 9 is shown above the second level 7, i.e. it is represented in a position that does not correspond to its actual arrangement in the battery 1 in the assembled state.

The thermal regulation element 9 comprises an intermediate cover 23 interposed between the first and second levels 5, 7, said intermediate cover 23 being made of a composite material and having first and second major faces 25, 27 turned respectively towards the first and second levels 5, 7.

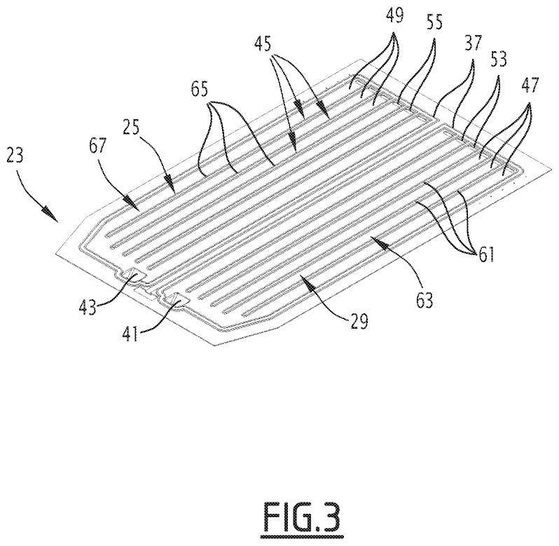

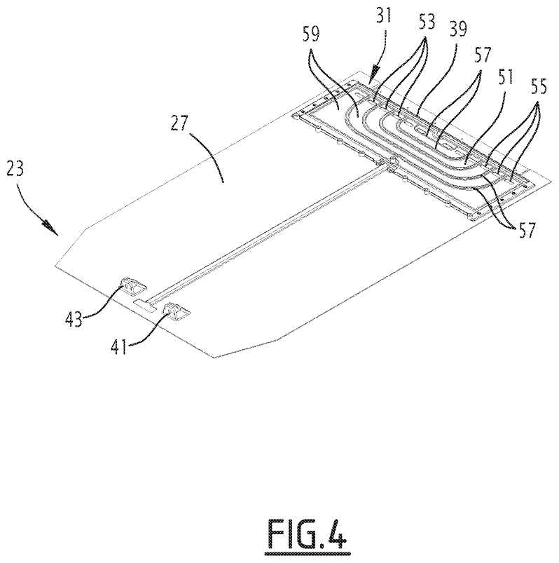

The first and second major faces 25, 27 of the intermediate cover 23, for the first embodiment of the thermal regulation element 9, are respectively represented in FIGS. 3 and 4.

The intermediate cover 23 has the general shape of a plate, of small thickness, extending generally in a plane perpendicular to the elevation direction E. It is produced according to the SMC (Sheet Mold Compound) method, or by the RTM (Resin Transfer Molding) method, or by any other method suitable for the thermocompression of pre-impregnated thermoplastics comprising cut or continuous fibers, such as TRE (Thermosetting Resin) and GMT (Glass Mat Thermoplastic).

As seen more particularly in FIG. 2, first and second volumes 29, 31 for circulating a thermal regulation fluid are formed on the first and second major faces 25, 27 of the intermediate cover 23.

Typically, the first flow volume 29 substantially covers the entire first major face 25 of the intermediate cover 23. The first flow volume 29 defines one or more recessed zones formed on the first major face 25 of the intermediate cover 23.

On the other hand, the second flow volume 31 only covers part of the second major face 27 of the intermediate cover 23. The second flow volume 31 typically defines at least one recessed area on the second major face 27 of the intermediate cover 23. Typically, the second flow volume 31 defines a single recessed area.

The thermal regulation element 9 further comprises a first thermally conductive plate 33 disposed against the first major face 25 of the intermediate cover 23 and closing the first flow volume 29 formed on the first major face 25 of the intermediate cover 23. It also comprises a second thermally conductive plate 35 disposed against the second major face 27 of the intermediate cover 23 and closing the second flow volume 31 formed on the second major face 27 of the intermediate cover 23.

The first and second thermally conductive plates 33, 35 are typically made of a metal, for example aluminum or an aluminum alloy, or any other suitable material.

The first thermally conductive plate 33 covers the entire first flow volume 29. It covers substantially the entire first major face 25 of the intermediate cover 23.

The second thermally conductive plate 35 covers the entire second flow volume 31.

It covers only a section of the second major face 27 of the intermediate cover 23.

The first thermally conductive plate 33 is sealed to the intermediate cover 23.

To this end, the first major face 25 of the intermediate cover 23 carries one or more glue paths 37. The or each recessed area of the first major face 25 of the intermediate cover 23 is entirely surrounded, over its entire periphery, by the or one of the glue paths 37.

The second thermally conductive plate 35 is preferably adhesively sealed on the intermediate cover 23. To do this, at least one glue path 39 is provided on the second major face 27 of the intermediate cover 23. The or each recessed area of the second major face 27 of the intermediate cover 23 is entirely surrounded, over its entire periphery, by the or one of the glue paths 39.

The intermediate cover 23 comprises a thermal regulation fluid inlet 41 at the first major face 25, and a thermal regulation fluid outlet 43 at the first major face 25, as shown in FIGS. 3 and 4.

The thermal regulation fluid inlet and outlet openings 41, 43 are located at a first longitudinal end of the intermediate cover 23. The second thermally conductive plate 35 is located at a second longitudinal end of the intermediate cover 23, opposite the first.

Advantageously, the intermediate cover 23 delimits at least one thermal regulation fluid flow channel 45 from the thermal regulation fluid inlet 41 to the thermal regulation fluid outlet 43 passing through the first and second flow volumes 29, 31.

In other words, the thermal regulation fluid entering the or each flow channel 45 through the thermal regulation fluid inlet 41, and flowing along the flow channel 45 to the thermal regulation fluid outlet 43, is forced to pass through the first and second flow volumes 29, 31.

To do this, the at least one flow channel 45 comprises an upstream section 47 formed on the first major face 25 of the intermediate cover 23 in the first flow volume 29, and fluidly connecting the regulation fluid inlet 41 to the second flow volume 31. It also comprises a downstream section 49 formed on the first major face 25 of the intermediate cover 23 in the first flow volume 29, and fluidly connecting the second flow volume 31 to the thermal regulation fluid outlet 43.

A first embodiment of the thermal regulation element 9 will now be described with reference to FIGS. 1 to 4.

In this first embodiment, the first and second flow volumes 29, 31 are separated from one another by a partition 51 pierced by at least one upstream communication opening 53 and at least one downstream communication opening 55.

In this case, the second major face 27 of the intermediate cover 23 bears reliefs 57 delimiting in the second flow volume 31 an intermediate section 59 of the at least one flow channel 45, fluidly connecting the at least one upstream communication opening 53 to the at least one downstream communication opening 55.

The upstream section 47 of the at least one flow channel 45 fluidly connects the thermal regulation fluid inlet 41 to the at least one upstream opening 53. Similarly, the downstream section 49 of the at least one flow channel 45 fluidly connects the at least one downstream opening 55 to the thermal regulation fluid outlet 43.

The partition 51 is an area of the intermediate cover 23 constituting a bottom for the second flow volume 31.

The thermal regulation element 9 preferably comprises several flow channels 45, parallel to each other. The upstream sections 47 extend longitudinally and are transversely juxtaposed with each other. They extend substantially over the entire longitudinal length of the intermediate cover 23.

The first major face 25 of the intermediate cover 23 carries ribs 61 that extend longitudinally and parallel to each other. The ribs 61 separate the upstream sections 47 from each other.

The partition 51 is pierced by an upstream opening 53 for each flow channel 45, i.e. for each upstream section 47.

The upstream sections 47 together define a hollow area 63 that is hollowed out of the first major face 25 of the intermediate cover 23, which is entirely surrounded by one of the glue paths 37.

Similarly, as may be seen in FIG. 3, the downstream sections 49 of the various flow channels 45 extend longitudinally parallel to one another. The first major face 25 of the intermediate cover 23 carries ribs 65 separating the downstream sections 49 from each other.

The partition 51 is pierced with a downstream opening 55 for each flow channel 45, i.e. for each downstream section 49.

The downstream sections 49 together form another hollow area 67 that is hollowed out of the first major face 25 of the intermediate cover 23, and which does not communicate directly with the hollow area 63 defined by the upstream sections 47. One of the glue paths 37 entirely surrounds this other hollow area 67.

The intermediate section 59 of each flow channel 45 is connected to the corresponding upstream section 47 through the corresponding upstream communication opening 53, and to the corresponding downstream section 49 via the corresponding downstream communication opening 55.

In the example shown, the intermediate sections 59 are C-shaped, the reliefs 57 being accordingly C-shaped ribs.

The upstream communication openings 53 and the downstream communication openings 55 are aligned along a transverse edge of the second flow volume 31. The upstream communication openings 53 are aligned along one half of said edge, while the downstream communication openings 55 are aligned along another half of said edge.

The second flow volume 31 consists of a single hollow area, formed on the second major face 27 of the intermediate cover 23. The second major face 27 of the intermediate cover 23 thus carries a single glue path 39 entirely surrounding the second flow volume 31.

As may be seen, in particular, in FIG. 2, the battery 1 comprises a tray 69 receiving the electricity storage cells 3 situated at the first level 5.

The tray 69 comprises a bottom 71 and a side wall 73 projecting from the bottom 71. The side wall 73 has a closed contour.

The tray 71 has an edge 75 defining an opening 77.

The edge 75 is defined by the side wall 73.

The opening 77 is closed by the thermal regulation element 9. The first thermally conductive plate 33 is in thermal contact with the electrical storage cells 3 of the first level 5.

More specifically, the electricity storage cells 3 are arranged with their upper faces turned towards the first thermally conductive plate 33. The upper surfaces 19 of the modules 11 are thus pressed against the first thermally conductive plate 33, directly or with the interposition as necessary of thermal paste between the upper surface 19 and the first thermally conductive plate 33.

The electricity storage cells 3 of the second level 7 are placed in line with the second thermally conductive plate 35.

By this is meant that the second level 7 electricity storage cells 3 cover the second thermally conductive plate 35. They are placed above this second thermally conductive plate 35 in the direction of elevation E.

The second thermally conductive plate 35 is therefore in thermal contact with the electricity storage cells 3 of the second level 7. More specifically, the lower surfaces 21 of the modules 11 assembling the second level 7 of electricity storage cells 7 are in contact with the second thermally conductive plate 35, directly or with the interposition of a thermal paste between the lower surface 21 and the second thermally conductive plate 35.

Moreover, the battery 1 also comprises a cover 79 fixed to the intermediate cover 23, wherein the electricity storage cells 3 of the second level 7 are housed between the cover 79 and the intermediate cover 23.

The tray 69 is advantageously made of a composite material obtained, in the case of thermosetting materials, by a compression molding method, the SMC (Sheet Molding Compound) method, or by a method of liquid resin injection molding the RTM (Resin Transfer Molding) method, or in the case of thermoplastics, it may be implemented by a method of compression molding, the GMT (Glass Mat Thermoplastics) method.

Similarly, the cover 79 is advantageously made of a composite material, obtained by the SMC method, or it may be made of a thermo-plastic fiber, reinforced or not.

Preferably, transverse reinforcements 81 are placed inside the tray 69, and rigidly fixed to the bottom 71. The electricity storage cells 3 of the first level 5 are distributed between the transverse reinforcements 81.

The transverse reinforcements 81 are typically metal bars typically extruded aluminum profiles, but may also be bars made of high mechanical quality steel (very high elastic limit type, for example greater than 700 MPa) stamped parallel to each other. They are regularly spaced from each other in the longitudinal direction L.

They are rigidly fixed to the bottom 71 by gluing, welding or brazing, or by any other suitable method.

Preferably, they are also attached to the side wall 73 at both ends.

The electricity storage cells 3, and more precisely the modules 11, are arranged between the transverse reinforcements 81. Thus, the electricity storage cells 3, and more precisely the modules 11, are arranged in several transverse rows. A transverse reinforcement 81 is disposed between each pair of adjacent rows.

The transverse reinforcements 81 make it possible to improve the resistance of the battery 1 to lateral shocks, in particular because they are rigidly fixed to the bottom 71. Because the thermal regulation element 9 is offset from the bottom 71 relative to the electricity storage cells 3, the bottom 71 is free and allows the attachment of transverse reinforcements 81.

Because of the rigidity conferred by the transverse reinforcements 81 rigidly fixed to the bottom 71, it is possible to reduce the size of the transverse reinforcements 81, and thus the thickness of the bottom 71. This allows considerable lightening of the battery 1.

Advantageously, the battery 1 also comprises at least one external reinforcement 83, disposed outside the tray 69 along the side wall 73, and rigidly fixed to at least one of the transverse reinforcements 81.

In the example shown, the tray 69 has a substantially rectangular bottom. The side wall 73 thus has two longitudinal sections 85 opposite to each other. The battery 1 comprises two outer reinforcements 83, each placed along one of the longitudinal sections 85. These outer reinforcements 83 extend over most of the longitudinal length of the tray 69. They are each fixed to all the transverse reinforcements 81. This attachment is made through screws, preferably of steel, or rivets, preferably of aluminum or steel.

The external reinforcements 83 make it possible to further reinforce the rigidity of the structure.

The flow of the thermal regulation fluid will now be detailed. The thermal regulation fluid enters the thermal regulation element 9 through the thermal regulation fluid inlet 41. It is distributed between the various flow channels 45 and passes through the upstream sections 47 to the upstream openings 53.

It then enters the second flow volume 31, and flows from the upstream openings 53 to the downstream openings 55 along the intermediate sections 59. It then passes through the downstream openings 55 and returns to the first flow volume 29. It passes from the downstream openings 55 to the temperature regulation fluid outlet 43 along the downstream sections 49.

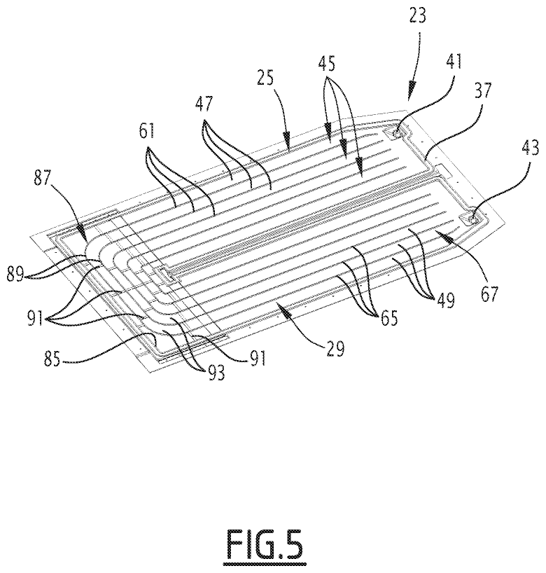

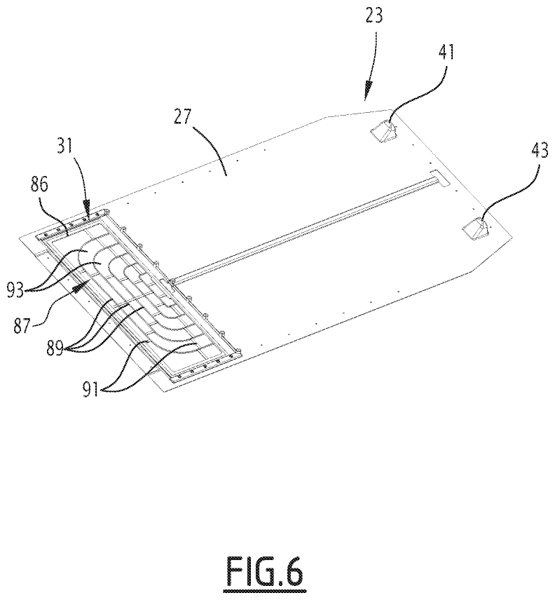

A second embodiment of the thermal regulation element 9 will now be described, with reference to FIGS. 5 to 7.

Only the points by which the second embodiment differs from the first will be detailed below. Identical elements or those ensuring the same function will be designated by the same references.

In the second embodiment, the intermediate cover 23 comprises a window 86 communicating with the first and second flow volumes 29, 31.

On the other hand, the intermediate cover 23 no longer includes the partition 51, which separated the first and second flow volumes from one another. This partition is replaced by the window 86.

Window 86 covers a large area. It typically covers at least 50% of the area of the second thermally conductive plate 35, preferably at least 75%, and more preferably at least 90%.

In the second embodiment, the upstream section 47 of the or each flow channel 45 fluidly connects the thermal regulation fluid inlet 41 to the window 86. Similarly, the downstream section 49 of the or each channel 45 fluidically connects the window 86 to the temperature regulation fluid outlet 43.

Consequently, the recessed areas 63, 67 formed respectively by the upstream sections 47 and the downstream sections 49 communicate with each other at the level of the first major face 25 of the intermediate cover 23 via the window 86.

The first major face 25 of the intermediate cover 23 accordingly has only one glue path 37, entirely surrounding this single hollow area.

On the second major face 27 of the intermediate cover 23, the glue path 39 follows the edge of the window 86.

Furthermore, the intermediate cover 23 advantageously comprises a grid 87 extending into the window 86 and guiding the thermal regulation fluid of the upstream section 47 of the or each flow channel 45 to the corresponding downstream section 49.

The grid 87 comprises a plurality of separators 89, and spacers 91.

The spacers 91 secure the separators 89 to each other and maintain the spacing between the separators 89. They also allow the grid 87 to be fixed to the edge of the window 86.

In the example shown, the separators 89 are bars.

The separators 89 define between them, for the or each flow channel 45, an intermediate section 93 connecting the upstream section 47 of the flow channel 45 to the corresponding downstream section 49.

In the example shown, the separators 89 are C-shaped. The intermediate sections 93 are also C-shaped.

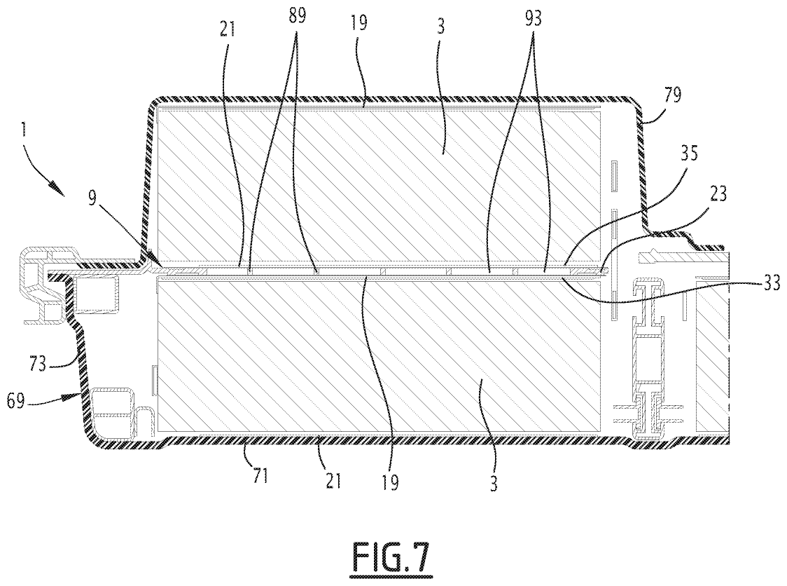

As may be seen in FIG. 7, the first and second thermally conductive plates 33, 35 bear against the separators 89, so that the sections 93 are fluidly separated from one another.

The flow of the thermal regulation fluid will now be detailed.

The thermal regulation fluid enters the thermal regulation element 9 through the thermal regulation fluid inlet 41. It is distributed in the various flow channels 45. It flows to the window 86 along the upstream sections 47. It then passes the intermediate sections 93 delimited between the separators 89. In doing so, it is in thermal contact both with the first thermally conductive plate 33 and with the second thermally conductive plate 35.

Then, it returns to the thermal regulation fluid outlet 43 following the downstream sections 49.

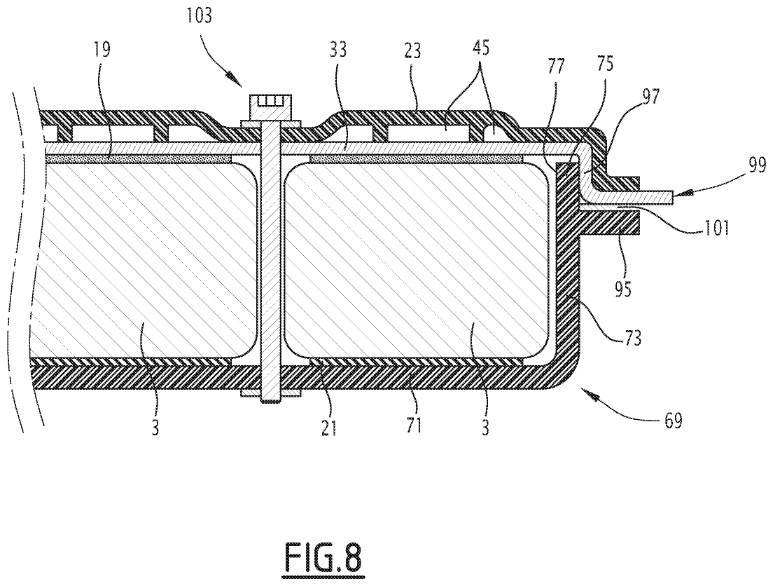

An advantageous aspect of the invention is shown in FIG. 8. It is applicable to the two embodiments described above.

According to this advantageous aspect, the first thermally conductive plate 33 covers the entire opening 77 and extends beyond the edge 75 outside the opening 77.

Thus, in the event of degradation of the intermediate cover 23 causing leakage of the thermal regulation fluid, this fluid does not flow inside the tray 69 but outside.

In the example shown in FIG. 8, the side wall 73 carries a shoulder 95 outside the tray 69. This shoulder 95 is located slightly below the edge 75, and extends over the entire periphery of the tray 69. The first thermally conductive plate 33 has at its periphery an upright edge 97 extended by an outward flange 99. The flange 99 is located opposite the shoulder 95, with the interposition of a seal and/or a waterproof adhesive 101.

The upright edge 97 is pressed against an outer surface of the side wall 73.

Such an arrangement is particularly advantageous for assembling the battery 1.

In fact, it is important for the first thermally conductive plate 33 to have good thermal contact with the electricity storage cells 3 of the first level 5. During the introduction of the thermal regulation element 9 at the opening 77, the thermal regulation element 9 is clamped against the tray 69, for example by a tie rod 103 of the type shown in FIG. 8.

The clamping is carried out in the elevation direction E. Such clamping is made possible by the use of the seal and/or the sealing glue 101. This makes it possible to bring the first thermally conductive plate 33 into contact with the upper face 19 of the modules 11.

The battery 1 described above and its thermal regulation element 9 may be of multiple types.

The number of cells 3 for storing electricity in the first level 5 and in the second level 7 can vary very widely. The second level 7 may comprise more cells 3 for storing electricity than the first level 5, contrary to what has been described above.

The first level 5 and the second level 7 are not necessarily stacked one above the other in the vertical direction. The elevation direction E might not be vertical and may adopt any other orientation.

In the examples described above, the second flow volume 31 covers a much smaller area than the first flow volume 29. In a variant, the second flow volume 31 is much larger, the second flow volume 31 having practically the same area as the first flow volume 29.

The first and second thermally conductive plates 33, 35 are not necessarily bonded to the intermediate cover 23. Alternatively, they may be fixed by any other means, for example by screws.

The thermal regulation element 9 may comprise one or more flow channels 45, depending on the needs and the size of the intermediate cover 23. This flow channel 45 may have a different arrangement of the examples described with reference to FIGS. 1 to 7.

The thermal regulation fluid is typically water, optionally with additives to prevent freezing. Alternatively, the thermal regulation fluid may be glycol water, or a fluorocarbon polymer type fluid or any type of mineral oil.

As indicated above, the thermal regulation element 9 is particularly light and efficient. The fact that the intermediate cover 23 is made of a composite material makes it possible to significantly reduce the weight of the thermal regulation element 9 compared with all-metal structures. The plates ensure excellent heat exchange quality.

The battery 1 is so arranged that the two levels 5, 7 of electricity storage cells 3 are served by a single thermal regulation element 9, with a single thermal regulation fluid circuit.

In particular, there are no connecting tubes inside the tray 69 or connector cover 79 and in which the thermal regulation fluid flows. The risk of contacting the electricity storage cells 3 with the thermal regulation fluid is extremely reduced.

1. Thermal regulation element for a battery for storing electricity, wherein the battery comprises:
a plurality of electricity storage cells arranged on a first level; and
a plurality of electricity storage cells arranged on a second level;
wherein the thermal regulation element comprises:
an intermediate cover interposed between the first and second levels, the intermediate cover being made of a composite material and having first and second major faces respectively facing towards the first and second levels, first and second flow volumes for a thermal regulation fluid being formed on the first and second major faces;
a first thermally conductive plate being disposed against the first major face of the intermediate cover and closing the first flow volume formed on the first major face of the intermediate cover; and
a second thermally conductive plate being disposed against the second major face of the intermediate cover and closing the second flow volume formed on the second major face of the intermediate cover.

2. Thermal regulation element according to claim 1, wherein the first thermally conductive plate and/or the second thermally conductive plate is sealingly adhered to the intermediate cover.

3. Thermal regulation element according to claim 1, wherein the intermediate cover comprises a thermal regulation fluid inlet at the first major face of the intermediate cover and a thermal regulation fluid outlet at the first major face of the intermediate cover, the intermediate cover delimiting at least one flow channel for the thermal regulation fluid from the thermal regulation fluid inlet to the thermal regulation fluid outlet, and passing through the first and second flow volumes.

4. Thermal regulation element according to claim 3, wherein the at least one flow channel comprises an upstream section formed on the first major face of the intermediate cover in the first flow volume and fluidically connecting the thermal regulation fluid inlet to the second flow volume, and a downstream section formed on the first major face of the intermediate cover in the first flow volume and fluidly connecting the second flow volume to the thermal regulation fluid outlet.

5. Thermal regulation element according to claim 4, wherein the first and second flow volumes are separated from each other by a partition pierced by at least one upstream communication opening and at least one downstream communication opening, the second major face of the intermediate cover bearing reliefs delimiting in the second flow volume an intermediate section of the at least one thermal regulation fluid flow channel fluidically connecting the at least one upstream communication opening to the at least one downstream communication opening, the upstream section fluidically connecting the thermal regulation fluid inlet to the at least one upstream opening, the downstream section fluidly connecting the at least one downstream opening to the thermal regulation fluid outlet.

6. Thermal regulation element according to claim 4, wherein the intermediate cover comprises a window communicating the first and second flow volumes, the window covering at least 50% of the surface of the second thermally conductive plate.

7. Thermal regulation element according to claim 6, wherein the upstream section fluidically connects the thermal regulation fluid inlet to the window, while the downstream section fluidically connects the window to the thermal regulation fluid outlet.

8. Thermal regulation element according to claim 6, wherein the intermediate cover comprises a grid extending into the window and guiding the thermal regulation fluid from the upstream section to the downstream section of said at least one thermal regulation fluid flow channel.

9. Thermal regulation element according to claim 3, wherein the thermal regulation fluid inlet and outlet are located at a first longitudinal end of the intermediate cover, the second thermally conductive plate being located at a second longitudinal end of the intermediate cover opposite to the first one.

10. Battery for storing electricity, the battery comprising:
a plurality of cells for storing electricity, arranged on a first level;
a plurality of cells for storing electricity, arranged on a second level; and
a thermal regulation element according to claim 1 interposed between the first and second levels, the first thermally conductive plate being in thermal contact with the electricity storage cells of the first level, the second thermally conductive plate being in thermal contact with the electricity storage cells of the second level.

11. Battery according to claim 10, wherein the battery comprises a tray housing the electricity storage cells of the first level, the tray having an edge that defines an opening closed by the thermal regulation element.

12. Battery according to claim 11, wherein the first thermally conductive plate covers the entire opening and extends beyond the edge outside the opening.

13. Battery according to claim 11, wherein the tray comprises a bottom, a side wall, and transverse reinforcements placed inside the tray and rigidly fixed to the bottom, the electricity storage cells of the first level being distributed between the transverse reinforcements.

14. Battery according to claim 13, wherein the battery comprises at least one outer reinforcement disposed outside the tray along the side wall and rigidly fixed to at least one of the transverse reinforcements.

15. Battery according to claim 10, wherein the battery comprises a cover fixed to the intermediate cover, the storage cells of electricity of the second level being housed between the cover and the intermediate cover.

16. Vehicle comprising an electricity storage battery according to claim 10.
